(19) United States
(12) Patent Application Publication
(10) Pub. No.: US 2020/0114535 A1
(43) Pub. Date: Apr. 16, 2020

(54) RAZOR

(71) Applicant: The Gillette Company LLC, Boston, MA (US)

(72) Inventors: Christopher James Wattam, Windsor (GB); Trevor John Whelan, Thatcham (GB); Anthony William Shorey, Thatcham (GB); Sean Peter Clarke, Henley on Thames (GB)

(21) Appl. No.: 16/600,955

(22) Filed: Oct. 14, 2019

Related U.S. Application Data
(60) Provisional application No. 62/744,809, filed on Oct. 12, 2018.

(51) Int. Cl. B26B 21/52; B26B 21/22

(52) U.S. Cl. CPC B26B 21/522; B26B 21/22

(57) ABSTRACT

The invention relates to a shaving razor. The shaving razor includes a handle having an elongated body having a proximal end and an opposing distal end. The proximal end has a cartridge connection mechanism and a razor cartridge connected to the cartridge connection mechanism. The elongated body has a first section nearest the proximal end and a second section nearest the distal end and a movement member connecting the first section to the second section. The movement member includes a unitary member having a central core extending along a longitudinal axis. A plurality of spaced apart projections extend outward from the central core and perpendicular to the longitudinal axis of the central core. Adjacent projections are spaced apart from one another to form open slots between adjacent projections.

### FIELD OF THE INVENTION

The invention relates to a razor having a handle which provides both consumer desirable ergonomics in terms of design and functionality particularly with regard to improved skin contact, whilst utilizing a cost-effective mechanism suitable for the disposable razor market.

### BACKGROUND OF THE INVENTION

The shaving razor market consists of razor systems where a cartridge is regularly replaced on a handle which may be used for many years and disposable razors which are usually discarded after one or a few uses. In contrast to the razor system market, the disposable market has seen limited consumer improvements primarily due to cost restraints. Nevertheless, there is still a need to provide disposable razor users with an improved shaving experience whilst ensuring that such products remain cost effective.

One current unmet need for disposable razor users is the provision of a more efficient shave which conforms to the facial contours whilst reducing any associated irritation.

The razor system market provides several technologies to improve the ability of the razor cartridge to follow the contours of the skin. For example Gillette's Flexball™ and Venus Swirl™ products provide for movement of the cartridge as described in U.S. Pat. Nos. 8,745,883 and 8,978,258. Alternative mechanisms are described in WO97/22446, U.S. Pat. Nos. 6,973,730, 5,560,106, EP2440375 and EP2511057.

However, these mechanisms require a high degree of engineering, separate components to provide discrete bearing surfaces and metal return springs to provide consistence performance and fatigue resistance. This results in relatively high manufacturing cost, in terms of materials and manufacturing methods and assembly. For razor systems this cost is justified by the lifetime of the handle and the number of cartridge replacements.

The disposable razor market however prevents the use of such complex mechanism from a cost perspective due to their short lifecycle.

Thus, is thus a need to provide a disposable razor with improved skin conforming motion which is simple to manufacture, has few moving parts, and requires low cost materials.

### SUMMARY OF THE INVENTION

The invention relates to a shaving razor comprising a handle having an elongated body having a proximal end and an opposing distal end. The proximal end comprising a cartridge connection mechanism for connecting to a razor cartridge. A razor cartridge connected to the connection mechanism. The elongated body comprises a first section nearest the proximal end and a second section nearest the distal end and a movement member connecting the first section to the second section. The movement member comprises a unitary member having a central core extending along a longitudinal axis. A plurality of spaced apart projections extending outward from the central core and perpendicular to the longitudinal axis of the central core. Adjacent projections being spaced apart from one another to form open slots between adjacent projections.

### BRIEF DESCRIPTION OF THE DRAWINGS

FIG. 1 shows a perspective view of a first embodiment of the invention.

FIG. 2 shows a top view of a first embodiment of the movement member invention.

FIG. 2A shows a section of the movement member taken along section lines 2A-2A of FIG. 2

FIG. 3 shows a top view of another embodiment of the movement member.

FIG. 4 shows a top view of another embodiment of the movement member.

FIG. 5 shows a top view of another embodiment of the movement member.

FIG. 6 shows a top view of the movement member of FIG. 2.

FIG. 7 shows another embodiment of the movement member.

FIG. 8 is a section of the movement member taken along section line 8-8 of FIG. 2.

FIG. 9 is a view of other central cores of the movement member of the present invention.

FIG. 10 is a side view of a test apparatus.

FIG. 11 is a side view of a test apparatus.

FIG. 12 shows another embodiment of the movement member.

### DETAILED DESCRIPTION OF THE INVENTION

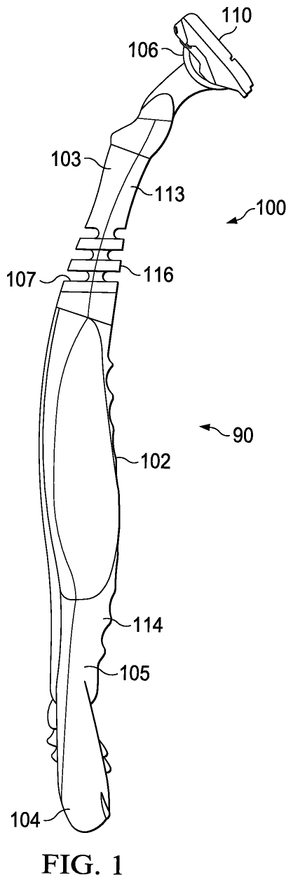

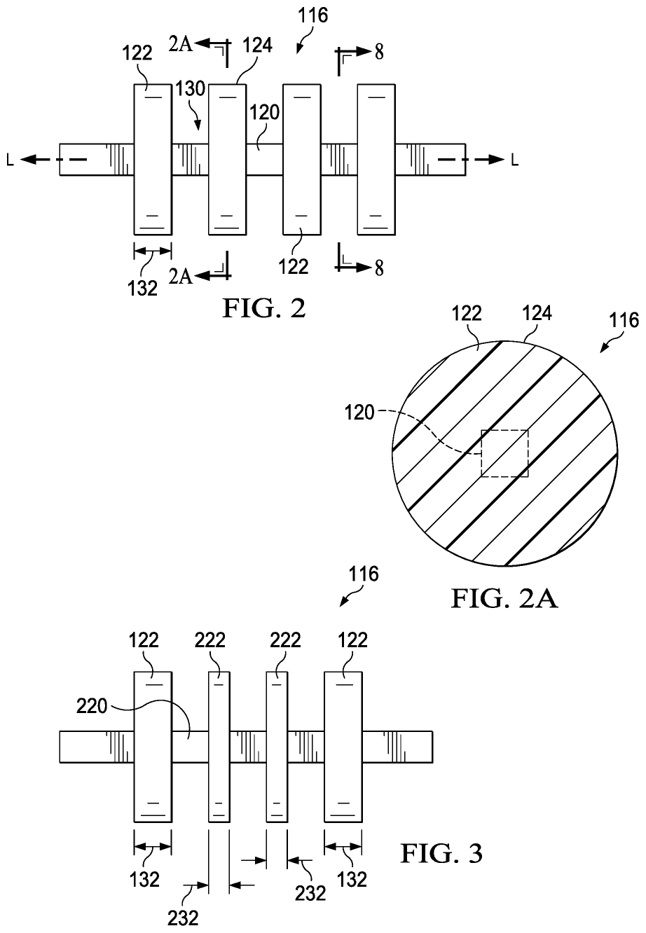

Referring now to FIGS. 1-2 there is a shown a shaving razor (90) of the present invention. The shaving razor (90) comprises a handle (100) having an elongated body (102) having a proximal end (103) and an opposing distal end (104). The proximal end (103) comprises a cartridge connection mechanism (106) for connecting to a razor cartridge (110). The elongated body (102) comprises a first section (113) nearest the proximal end and a second section (114) nearest the distal end and a movement member (116) connecting the first section to the second section. The movement member (116) comprises a unitary member having a central core (120) extending along a longitudinal axis (L-L). A plurality of spaced apart projections (122) extend outward from the central core. Adjacent projections (122) are spaced apart from one another to form open slots (130) between adjacent projections.

The elongated body (102) may be provided in any shape or form and is preferably ergonomic to allow easy handling by the consumer. The elongated body may be symmetrical or asymmetrical and is preferably symmetrical in form. In one embodiment, the elongated has a curved shape. The elongated body (102) of the handle has an outer surface (105) and an interior body (107).

The spaced apart projections (122) extend in a direction perpendicular to the longitudinal axis L-L of the central core (120). Each projection (122) has a thickness dimension (132). In the embodiment shown in FIG. 2 each projection (122) has the same thickness dimension. In addition, each projection (122) has the same shape. Each projection (122) has an outer surface (124) remote from the central core (120). The projections (122) have a thickness dimension from 0.1 mm to 5 mm

Referring to FIG. 2A, the projections (122) have a circular shape when viewed along longitudinal axis L-L. The projections may have other shapes such as square, oval, rectangular and polygon.

In the embodiment of movement member (116) shown in FIG. 3 projections (122) have the same thickness dimension (132). Projections (222) have the same thickness dimension (232). Thickness dimension (132) is greater than and different from thickness dimension (232). In addition, each projection (122) has the same shape. The thickness dimensions (132, 232) of projections (122, 222), respectively, are substantially uniform throughout the respective projection from central core (220) to their outer surfaces (124, 224).

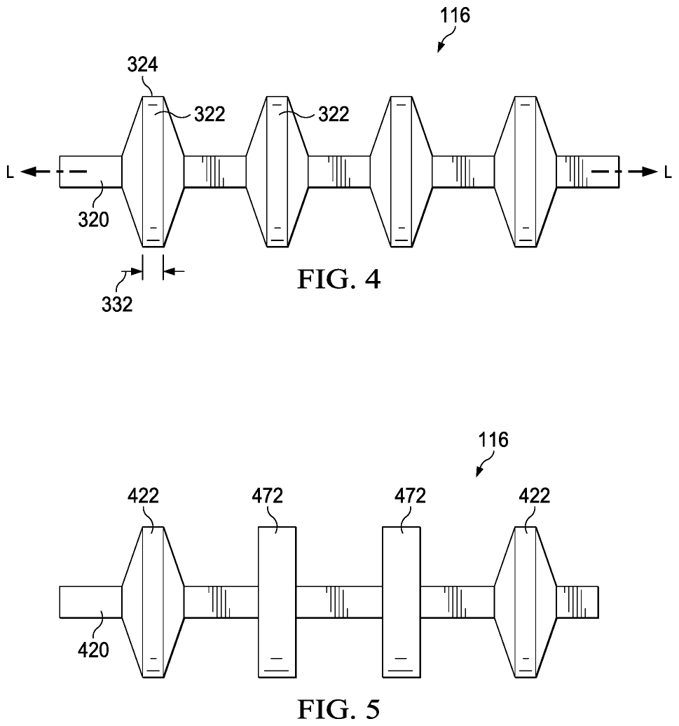

In the embodiment of movement member (116) shown in FIG. 4 projections (322) have a non-uniform thickness dimension (332). Near and adjacent the central core (320) the projection has its largest thickness dimension and at the outer surface (324) the projection has its smallest thickness dimension.

In the embodiment shown in FIG. 5, projections (422) and (472) extend outward from central core (420). Projections (422) have a different shape from projections (472).

Referring now to FIG. 2, the movement member (116) has three slots (130) between projections (122). The movement member (116) may include any number of slots (130) depending on the movement desired. The size of each slot (130) may be selected to achieve the desired movement of the connections member (116) during shaving.

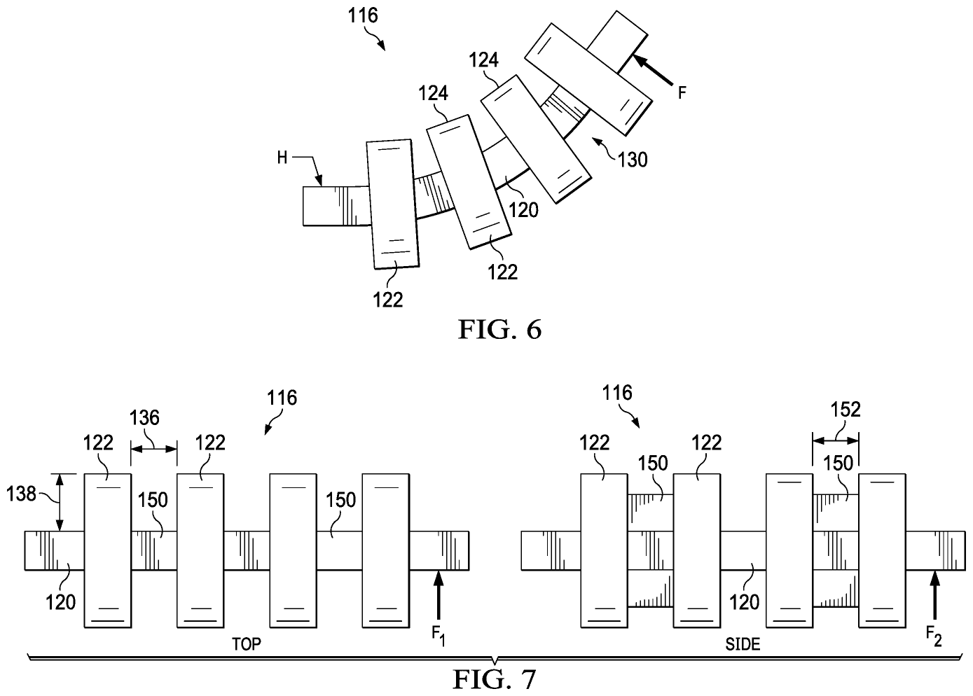

Referring now to FIG. 6, there is shown the movement member (116) of FIG. 2. Here movement member (116) is part of a razor, not shown. As the user shaves a portion of the handle is held in the user's hand represented by (H). During shaving a force is applied to the razor cartridge which translates to a force (F) being applied to one end of the movement member (116). As force (F) is applied to one end of the movement member (116) the central core (120) bends in response. During bending of the central core (120), the end surfaces (124) of projections (122) positioned away from the force (F) move closer to one another and the end surfaces (124) of the projections (122) positioned with the force (F) move away from one another. The amount of movement of central core (120) is limited by the adjacent projections coming into contact with one another preventing further movement of the central core. With larger slots (130) between adjacent projections (122) more movement can be experienced by the movement member.

Whilst not being bound by any theory it is believed that the provision of slots between projections as described herein in the movement member of the handle enables movement of the handle in at least one plane to improve skin contact of the razor cartridge with the skin.

According to the invention, each slot (130) extends from the outer surface of handle body into the interior body of the handle toward the central core (120). The central core (120) is therefore defined by the slots (130). Having the outer surfaces (124) of projections (122) generally aligned with the outer surface of the handle allows the user to rest part of the user's hand on the movement member during shaving. This is believed to be desirable as the user can then feel the movement of the movement member (116) during shaving. The ability for the user to have tactile contact with the movement member (116) during shaving movement increases the overall confidence of the user with the shaving experience.

In a preferred embodiment the slots (130) reduce the cross-sectional area and or volume of the movement member (116). The size, shape, volume and material for the movement member can be selected to obtain the desired movement of the movement member under typical shaving conditions.

Referring now to FIG. 7, there is shown a top and side view of a movement member (116). Movement member (116) comprises projections (122) and central core (120). Movement member (116) also comprises slot separators (150). Slot separators (150) restrict the movement of the central core (120). As the force F1 is applied to the movement member (116) the movement of the central core (120) is restricted to a first amount by the slot separators (150). As the force F2 is applied to the movement member (116) the movement of the central core is restricted to a second amount by the slot separators (150). The force F1 is perpendicular to the force F2. The first amount of restricted movement when force F1 is applied is less than the second amount of restricted movement when force F2 is applied. Thus, when force F1 is applied the movement member (116) may move by a greater amount than when force F2 is applied to the movement member (116). Such slot separators (150) are desirable when designing the movement member to have pre-determined movements amounts or limitations in a certain direction. The number, orientation, shape and dimension of the slot separators control the amount of movement for the movement member in any particular direction.

The dimensions of each slot (130), may all be the same or different. Each slot (130) may independently have a uniform cross section or may increase or decrease as they extend from the outer surface of the handle to the central core. In one preferred embodiment the slots decrease in cross section towards the central core. In some embodiments all slots have substantially identical dimensions. In some embodiments each slot has a different dimension from the next. The dimensions of the slots in addition to the number of pairs of slots and the materials of the movement member will determine the movement thereof and are selected accordingly.

The overall shape of each slot is also determined by the outer surface contour of the handle, the shape of the projections and the shape of the central core. The slot may for example have a substantially rectangular cross-section when viewed from the side. The slot may have other shapes depending on the adjacent structures forming the slot.

Each slot may independently have a width (136) of from 0.1 mm to 2 mm, preferably 0.5 mm to 1.5 mm, more preferably from 0.75 to 1.25 mm and a depth (138) of from 0.5 mm to 5.0 mm

The dimensions of each of the slot separators (150) may be the same or different. The slot separators slots may have a width (152) of from 0.1 mm to 2 mm, preferably 0.5 mm to 1.5 mm, more preferably from 0.75 mm to 1.25 mm

In one embodiment the slot width is substantially the same as a slot separator width.

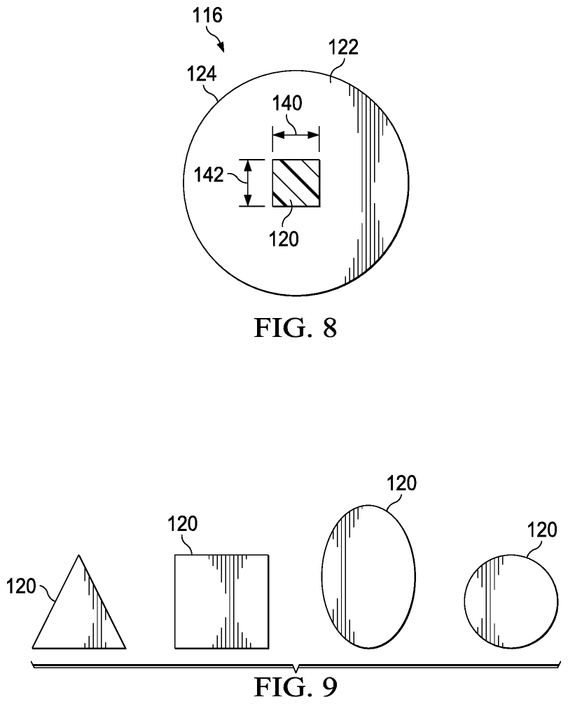

As described above the resilient movement member has a central core which extends through substantially the center of the resilient flexible portion. Referring now to FIG. 8, there is a shown a cross-section of movement member (116). Central core (120) has a rectangular cross-sectional shape. The central core has a width dimension (140) and a height dimension (142). The width dimension (140) is from 0.5 mm to 4.0 mm, preferably 1.0 mm to 3.0 mm, more preferably from 2.0 mm to 2.5 mm The height dimension (142) is from 0.5 mm to 4.0 mm, preferably 1.0 mm to 3.0 mm, more preferably from 2.0 mm to 2.5 mm Referring now to FIG. 9 there is shown other cross-sectional shapes for the central core (120). The central core may have a cross-sectional shape that is triangular, square, oval, circular or other shape.

Handle body (102) and the movement member (116) may be formed from any suitable material known in the field, preferably the entire handle body (102) is formed of resilient material. Preferred materials include thermoplastics such as polypropylene, acrylonitrile butadiene styrene, high impact polystyrene, polycarbonate, polyphenylene ether/polystyrene blend; metals, or alloys such as zinc, aluminium, steel, titanium, stainless steel, brass; carbon fibre, and/or mixtures thereof.

The handle body (102) and movement member (116) may be formed from same material or from different material. In one embodiment the handle body (102) and the connections member (116) are formed from the same material, preferably polypropylene.

The movement member allows the handle to flex during shaving. The flexing during shaving allows the razor cartridge to maintain contact with the user's skin during shaving providing for an improved shave as opposed to a razor having a handle that does not flex during shaving.

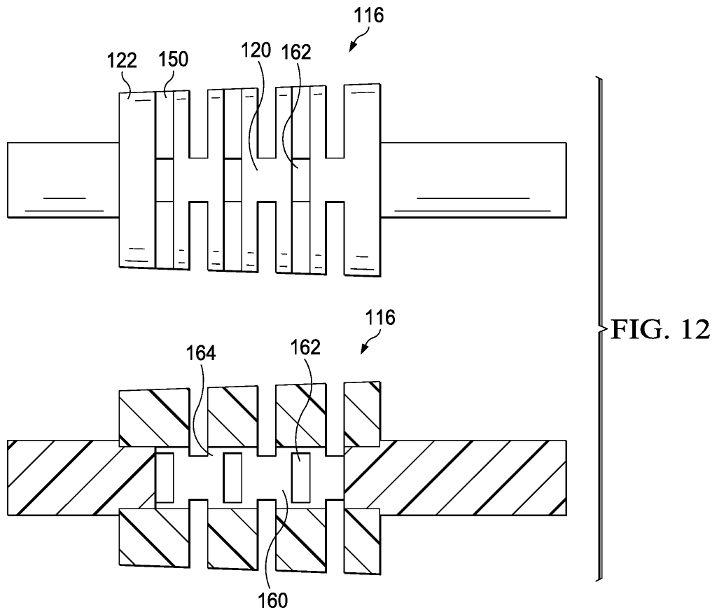

Referring now to FIG. 12, there is shown a top and sectioned view of a movement member (116). Movement member (116) comprises projections (122) and central core (120). Movement member (116) also comprises slot separators (150). The projections (122) and slot separators may have the dimensions and shapes of those disclosed in the above-mentioned embodiments. The central core (120) is hollow having a central bore (160). The presence of the central bore (160) in the hollow central core (120) allows for increased flexibility and/or movement of the movement member (116). The central core (120) also comprises openings (162) extending from the exterior (164) of the central core (120) to the central bore (160).

### Methods of Manufacture

A shaving razor handle and or body thereof may be manufactured using any method known in the art. Suitable methods include injection moulding and die casting and optionally ‘additive or subtractive manufacturing’ techniques may be used. The first section, second section and movement member may be moulded as a single unitary structure of the same material. The first section, second section and movement member may all be moulded individually as separate unitary structures and then secured together. When moulded individually the first section, second section and movement member may be moulded of the same or different materials.

### Razor Cartridge

According to the invention, the razor (90) is provided with a razor cartridge (110). The razor cartridge (110) may be pivotally connected to the cartridge connecting structure (106) of the handle. The razor cartridge (110) typically comprises one or more elongated blades usually positioned between a first and second end, the one or more elongated blades comprising a tip or sharpened end extending towards the first end. The razor cartridge can include and number of blades. For example, U.S. Pat. No. 7,168,173 generally describes a Fusion® razor that is commercially available from The Gillette Company LLC and which includes a razor cartridge with multiple blades. Additionally, the razor cartridge may include a guard as well as a skin engaging member. A variety of razor cartridges can be used in accordance with the present invention. Non-limiting examples of suitable razor cartridges, with and without fins, guards, and/or shave aids, include those marketed by The Gillette Company LLC under the Fusion®, Venus® product lines as well as those disclosed in U.S. Pat. Nos. 7,197,825, 6,449,849, 6,442,839, 6,301,785, 6,298,558; 6,161,288, and U.S.2008/060201. Those of skill in the art will understand that the lubricating member can be used with any currently marketed system or disposable razor, including those having 2, 3, 4 or 5 blades.

In some embodiments, at least one lubricating member is located on the portion of the cartridge that contacts skin during the hair removal process, forward and/or aft of the blades. A feature “forward” of the one or more elongated edges, for example, is positioned so that the surface to be treated with by the hair removal device encounters the feature before it encounters the elongated edges. A feature “aft” of the elongated edge is positioned so that the surface to be treated by the hair removal device encounters the feature after it encounters the elongated edges. Where more than one lubricating member is provided on the hair removal device, they can be the same (identical) or different, in terms of physical shape/structure and/or chemical composition, and one or more of them may comprise the spray coated particulate.

In some embodiments, a plurality (e.g. 2, a first and second) of lubricating members may be provided on the hair removal head, with the first skin engaging member comprising the same composition or different. These lubricating members may be placed collectively (for example adjacent to one another) ahead of or behind the elongated edges (e.g. blades on a razor cartridge), including side by side, or separately with one ahead of the elongated edges and the other behind.

The lubricating member may be free standing utilizing a suitable attachment means such as adhesive or may be contained at least partially within a container. In some embodiments, the razor cartridge comprises a guard comprising at least one elongated flexible protrusion to engage a user's skin. The at least one flexible protrusion may comprise flexible fins generally parallel to said one or more elongated edges. The at least one flexible protrusion may additionally or alternatively comprise flexible fins comprising at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface). In some embodiments, the lubricating member is positioned on the cartridge aft of the guard and forward of the elongated edge. In another embodiment, the lubricating member is positioned on the cartridge forward of the guard. This embodiment can be particularly useful to deliver the lubricating member prior to contact with the guard.

### Flexibility Determination/Methods In Use Deflection Test Method

### Apparatus:

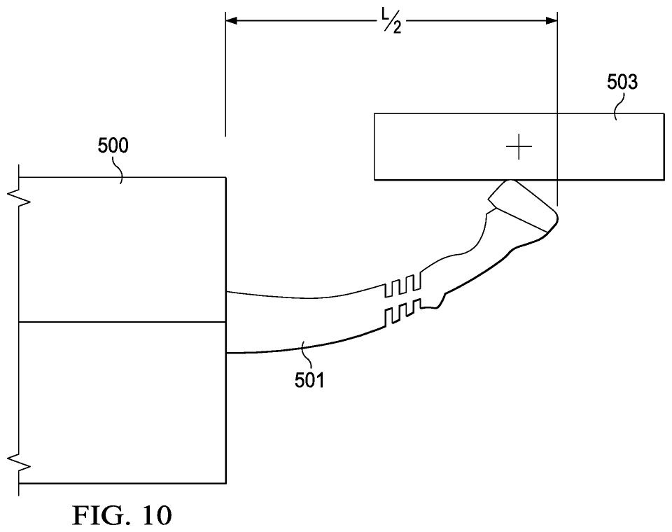

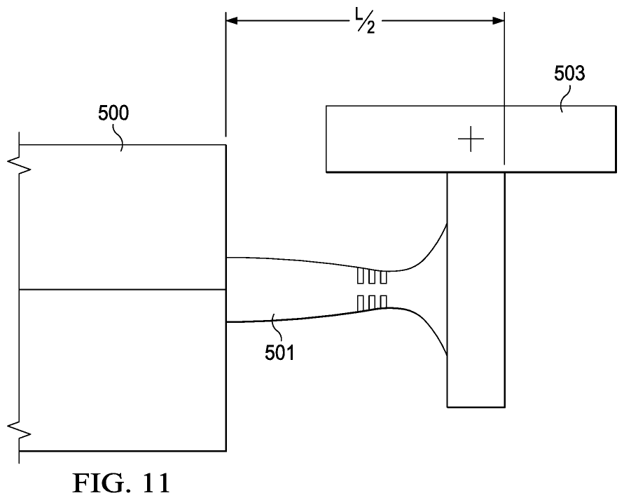

Referring now to FIGS. 10-11, a fixture (500) to clamp the razor (501) such that the distal end of the handle is held statically up to the mid-point of the second section of the handle. Fixture (500) should be made of suitable uncompressible material to support razor without deflection (at intended test loads) this includes metal, MDF or plastic.

A flat plate (503) that extends at least the full width of the test product is used. The bending Stiffness equipment is an Instron 5564 using a Static Load Cell rated to 10N.

### Method:

1. Allow all test products to equilibrate at standard temperature and pressure (20° C. and 1 Atm) for 1 hr.
2. Check Load Cell is rated at 10N and in calibration. Set up control software to run a compressive test—such that the equipment will run and record the test by feeding the probe vertically downward at a rate of 3.0 mm/sec.
3. Determine the maximum length (L) and midpoint of the device as shown in FIG. XX. Mark the test product across it's midpoint of the second section on both front and back surfaces.
4. Mount the flat plate to the load cell.
5. Securely fix the fixture to the Instron platen.
6. Place the test product into the fixture such that it is clamped up to the mid-point of the test product. The fixture should orient the test product such that the slots are vertically aligned to the probe's axial axis and the probe is aligned to the razor cartridge. The mid plane of the probe should correspond to the mid plane of the razor cartridge.
7. Zero load readouts. Slowly lower the probe until the load readout reaches a maximum of 5 gf: indicating contact. Check that the center of the probe is correctly aligned with the midpoint of the razor. Zero both load and deflection readouts.
8. Start the test. Record vertical deflection (mm) incrementally up to 500 grams force. Record the mean stiffness between 0.3 mm and maximum deflection.
9. Retract probe to the zero position.
10. Remove the razor from the support blocks.
11. Repeat steps 6-9 3 times and record the mean (and standard deviation) over these repeats.
12. Depending on the test product slot configuration rotate the test product through 90 degrees to measure the stiffness in all the directions of intended movement. Place the test product in the support blocks as shown in FIG. 11 such that 50% of the test products' maximum length is unsupported, and the remainder is supported by the support blocks and allow to stabilize.

Repeat steps 6-12 until all the directions of intended movement have been measured. The stiffness of the movement member according to the above method is from 0.4N/mm-3.0N/mm

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

What is claimed is:

1. A shaving razor comprising a handle having an elongated body having a proximal end and an opposing distal end, the proximal end comprising a cartridge connection mechanism, a razor cartridge connected to the connection mechanism, the elongated body comprising a first section nearest the proximal end and a second section nearest the distal end and a movement member connecting the first section to the second section, the movement member comprising a unitary member having a central core extending along a longitudinal axis, a plurality of spaced apart projections extend outward from the central core and perpendicular to the longitudinal axis of the central core, adjacent projections being spaced apart from one another to form open slots between adjacent projections.

2. The shave razor of claim 1, wherein each projection has a thickness dimension.

3. The shaving razor of claim 2, wherein the projections have different thickness dimensions from one another.

4. The shaving razor of claim 1, wherein each slot has a slot width from 0.1 mm to 2.0 mm

5. The shaving razor of claim 1, wherein the movement member has a stiffness from 0.4N/mm-3.0N/mm

6. The shaving razor of claim 1, wherein the projections have the same shape.

7. The shaving razor of claim 1, wherein the projections have different shapes.

8. The shaving razor of claim 1, further comprising a slot separator between adjacent projections.

9. The shaving razor of claim 1, wherein the central core is hollow.

10. The shaving razor of claim 1, wherein the central core has openings.
